(19) United States
(12) Patent Application Publication
(10) Pub. No.: US 2017/0197108 A1
(43) Pub. Date: Jul. 13, 2017

(54) EXERCISE MAT AND METHOD FOR PLACING ACCESSORIES

(71) Applicant: JANNIE EDDINS, CARROLLTON, TX (US)

(72) Inventor: JANNIE EDDINS, CARROLLTON, TX (US)

(21) Appl. No.: 15/287,573

(22) Filed: Oct. 6, 2016

Related U.S. Application Data
(60) Provisional application No. 62/387,941, filed on Jan. 12, 2016.

(51) Int. Cl. A63B 21/00; A63B 71/00; F16M 13/00

(52) U.S. Cl. CPC A63B 21/4037; F16M 13/00; A63B 71/0036

(57) ABSTRACT

An exercise mat and method for placing exercising accessories comprises a flexible exercise mat having a first and second printed indicia thereon. The first printed indicia, corresponds to locations of accessories on exercise mat. The second printed indicia, corresponds to names of the accessories on the exercise mat. The exercise mat is flexible to use and roll.

### BACKGROUND OF THE INVENTION

1. Field of the invention

The subject invention pertains to the field of exercise mat, more particularly to an exercise mat having printed indicia thereon for placing accessories.

2. Description of the Prior Art

Gym floors are not always very sanitary places. They typically teem with bacteria, some of which are merely smelly, and some of which are more dangerous (such as MRSA). A person doing exercise has to place his or her accessories on dirty floor that touch the floor in direct contact bacteria.

One way to deal with the problem, of course, is to wash the accessories before use; however, this is hard to commit to on a regular basis. Therefore, a need exists for a fold-and-roll mat to keep accessories sanitary that is easier to fold in exactly the right place for the edges to line up precisely when it is rolled up, and that does not have a “bump” in the middle or risk damaging the material of the mat.

### SUMMARY OF THE INVENTION

An exercise mat and method for keeping the accessories sanitary comprises a low-impact exercise mat having first and second printed indicia thereon. The first printed indicia, corresponds to the location of the accessories on the exercise mat. The second printed indicia, corresponds to the names of the accessories on the exercise mat.

An object of the present invention is to provide an exercise mat that prevents the accessories from coming into contact with the dirty exercise floor.

Another object of the present invention is to provide an exercise mat that is easier to keep accessories sanitary.

Another object of the present invention is to provide an exercise mat that is easy to fold or roll to fit in any size gym bag or purse. The mat is also machine washable, suitable to use outdoor of everyday eating, heat resistant, and non-skidding.

It is a further object of the present invention to provide an exercise mat having printed indicia thereon, wherein the indicia printed on the face of the mat allows for definitive direction given to a user.

It is a still further object of the present invention to provide an exercise mat having first and second printed indicia thereon.

It is a still further object of the present invention to provide an exercise mat having a first printed indicia corresponding to the location of the accessories and a second printed indicia corresponding to the names of the accessories.

Further objects and advantages of the present invention will become apparent by reference to the following detailed disclosure of the invention and appended drawings wherein like reference numerals refer to the same feature, component or element.

### BRIEF DESCRIPTION OF DRAWINGS

FIG. 1 is a front elevational view of an exercise mat according to the present invention.

FIG. 2 is a front perspective view of an exercise mat according to the present invention.

FIG. 3 is a rear elevation view of an exercise mat according to the present invention.

FIG. 4 is a side plan view of an exercise mat according to the present invention.

### DETAILED DESCRIPTION OF THE INVENTION

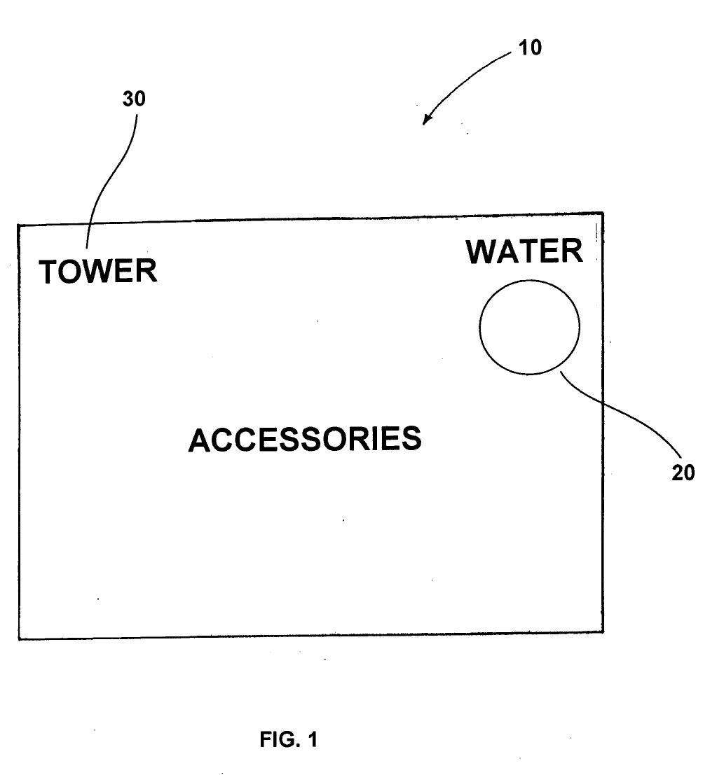

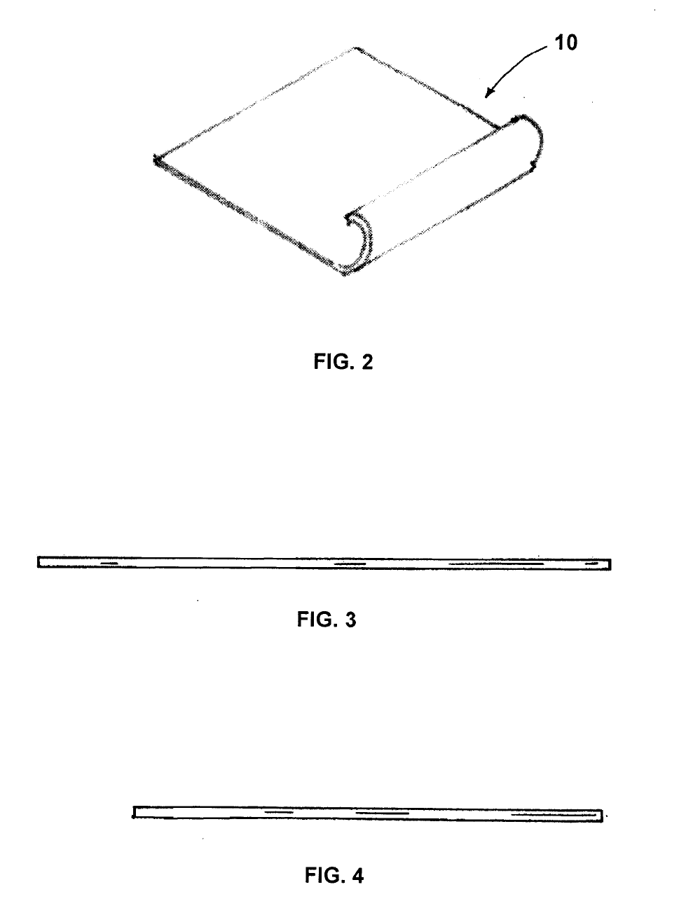

Referring now to FIG. 1 the apparatus according to the present invention is illustrated and generally referred to by reference numeral 10.

The exercise mat 10 comprises a first printed indicia 20 and a second printed indicia 30. The first printed indicia 20 generally comprises a plurality of symbols or colors that correspond to the locations of the accessories on the exercise mat 10. The second printed indicia 30 generally comprises a plurality of letters that correspond to the names of the accessories on the exercise mat 10. The exercise mat 10 is generally intended for use of keeping the accessories from being unsanitary while doing exercise, dance, or therapy.

The mat is generally a textured mat that is brightly designed with numerical and directional symbols. The mat is made from a padded material that results in a reduced impact on the user during exercise. There are different sizes of the mat available for participants to choose. The size option serves the purpose of allowing smaller sized participants a more reasonable range of motion. Furthermore, it also provides a choice for participants who desire a lower range of motion for decreased intensity.

The indicia printed on the mat allow for a method for utilizing definitive instructions on the mat by a user to place accessories on the mat. This feature lessens the ambiguity usually associated with cues exchanged in most group fitness settings. The numerals and cardinal directions make cueing very clear and precise.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is:

1. An exercise mat for placing exercising accessories, comprising:
(a) a flexible mat having a plurality printed indicia of items thereon;
(b) a first printed indicia corresponding to locations of the accessories to be placed on the mat;
(c) a second printed indicia corresponding to names of the accessories to be placed on the mat;

2. The mat of claim 1 wherein first printed indicia is selected from the group consisting of numbers, figure symbols, and colors.

3. The mat of claim 1 wherein said first printed indicia, comprises figure symbols.

4. The mat of claim 1 wherein said first printed indicia, comprises numbers.

5. The mat of claim 1 wherein said first printed indicia, comprises colors.

6. The mat of claim 1 wherein said second printed indicia is selected from the group consisting of letters symbols and colors.

7. The mat of claim 1 wherein said second printed indicia, comprises letters.

8. The mat of claim 1 wherein said second printed indicia, comprises colors.

9. A method of utilizing an exercise mat having a plurality of indicia printed thereon, comprising:
(a) obtaining an exercise mat having a plurality of printed indicia thereon, said mat having a first printed indicia and a second printed indicia wherein said first printed indicia corresponding to locations of the accessories on said mat and wherein said second printed indicia corresponding to names of the accessories on said mat; and
(b) utilizing the mat wherein user places the accessories following the locations and names corresponding with said first and second printed indicia, respectively, on said mat.

13. The method of claim 9 wherein said exercise mat is utilized for exercise.

14. The method of claim 9 wherein said exercise mat is utilized for dance.

15. The method of claim 9 wherein said exercise mat is utilized for therapy.
